(19) United States
(12) Patent Application Publication
(10) Pub. No.: US 2014/0100993 A1
(43) Pub. Date: Apr. 10, 2014

(54) Product Purchase in a Video Communication Session

(71) Applicant: Rico Farmer, San Francisco, CA (US)

(72) Inventor: Rico Farmer, San Francisco, CA (US)

(21) Appl. No.: 13/645,399

(22) Filed: Oct. 4, 2012

(51) Int. Cl. G06Q 30/06

(52) U.S. Cl. 705/27.1

(57) ABSTRACT

Various implementations for purchasing products in a video communication session are described. In one example implementation, a system provides a video communication session stream associated with a multi-user video communication session to a client device of a user for presentation. The system analyzes the video communication session stream in real time for a purchasable product being depicted by the video communication session stream and determines product data for the purchasable product based on the analyzing of the video communication session stream. The product data is transmitted by the system to the client device for presentation. The system can receive a product selection from the client device selecting the purchasable product and enable a purchase of the purchasable product by the user.

### BACKGROUND

The specification relates to electronic communication. In particular, the specification relates to purchasing products in a video communication session.

In recent years, people have increasingly been using their electronic devices to communicate with one another. For example, people communicate using video conferencing services, which can enable users to see one another in real-time, and in some cases, share electronic files and such. In some cases, a person participating in such a video conference may include products in his/her outbound video stream for the other people participating in the video conference to view. However, users presented with these products in their inbound video conference streams are limited in obtaining additional information about such products using existing systems because existing systems are often unable to identify, provide more information about, or an option to purchase a product displayed in an impromptu manner by a person participating in the video conference.

While some video broadcasting systems can provide users with video that includes product information about the items depicted by it, these systems generally require a video technician to review the video beforehand to identify the purchasable products and then input information about those products. As such, these systems are impractical when applied to video conferencing as video conferences are generally conducted in real-time.

### SUMMARY

According to one innovative aspect of the subject matter in this disclosure, a system provides a video communication session stream associated with a multi-user video communication session to a client device of a user for presentation. The system analyzes the video communication session stream in real time for a purchasable product being depicted by the video communication session stream and determines product data for the purchasable product based on the analyzing of the video communication session stream. The product data is transmitted by the system to the client device for presentation.

In general, another innovative aspect of the subject matter described in this disclosure may be embodied in methods that include providing a video communication session stream associated with a multi-user video communication session to a client device of a user for presentation; analyzing the video communication session stream in real time for a purchasable product being depicted by the video communication session stream; determining product data for the purchasable product based on the analyzing of the video communication session stream; and transmitting the product data to the client device for presentation.

Other implementations of one or more of these aspects include corresponding systems, apparatus, and computer programs, configured to perform the actions of the methods, encoded on computer storage devices.

These and other implementations may each optionally include one or more of the following features. For instance, the operations may further include that the analyzing of the video communication session stream includes detecting an object depicted by the video communication session stream and matching the object to one of a plurality of products stored in a product database to identify the purchasable product; receiving a product identification request; that the analyzing of the video communication session stream in real time is performed responsive to the receiving of the product identification request; receiving a product selection from the client device selecting the purchasable product; enabling a purchase of the purchasable product by the user; and receiving a request to engage in the video communication session from the client device prior to the providing of the video communication session stream. For instance, the features may further include that the object is a media object, the product database stores a plurality of media objects respectively associated with the plurality of products, and the matching of the object includes comparing the media object to the plurality of media objects to identify the purchasable product; and the product data includes one or more of information describing a location of the purchasable product within the video communication session stream and attribute information for the purchasable product.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for purchasing a product in a video communication session.

FIG. 2A is a block diagram illustrating an example social network server.

FIG. 2B is a block diagram illustrating an example video communication engine.

FIG. 3A is a block diagram illustrating an example client device.

FIG. 3B is a block diagram illustrating an example client application.

FIG. 4 is a flowchart of an example method for identifying and enabling the purchase of a product in a video communication session.

FIG. 5 is a flowchart of a further example method for identifying and enabling the purchase of a product in a video communication session.

FIG. 6 is a flowchart of another example method for identifying and enabling the purchase of a product in a video communication session.

FIG. 7 is a graphic representation of an example user interface for displaying a video communication session stream to a user highlighting a product and providing for the purchase of the product.

### DETAILED DESCRIPTION

In some embodiments, the technology described herein enables a user participating in a multi-user video communication session to purchase products displayed in the session. For instance, the technology provides a video communication session stream associated with a multi-user video communication session to a client device of a user for presentation and receives a product identification request. The product identification request may, for instance, be received from the user or from another user participating in the session.

The technology can then analyze the video communication session stream in real time for purchasable products and determine product data for one or more purchasable products based on the analysis, which is transmitted to the client device for presentation. In some instances, the product data is used to highlight any purchasable products to the user. The technology system can then receive a product selection from the client device selecting a purchasable product and enable a purchase of the purchasable product by the user.

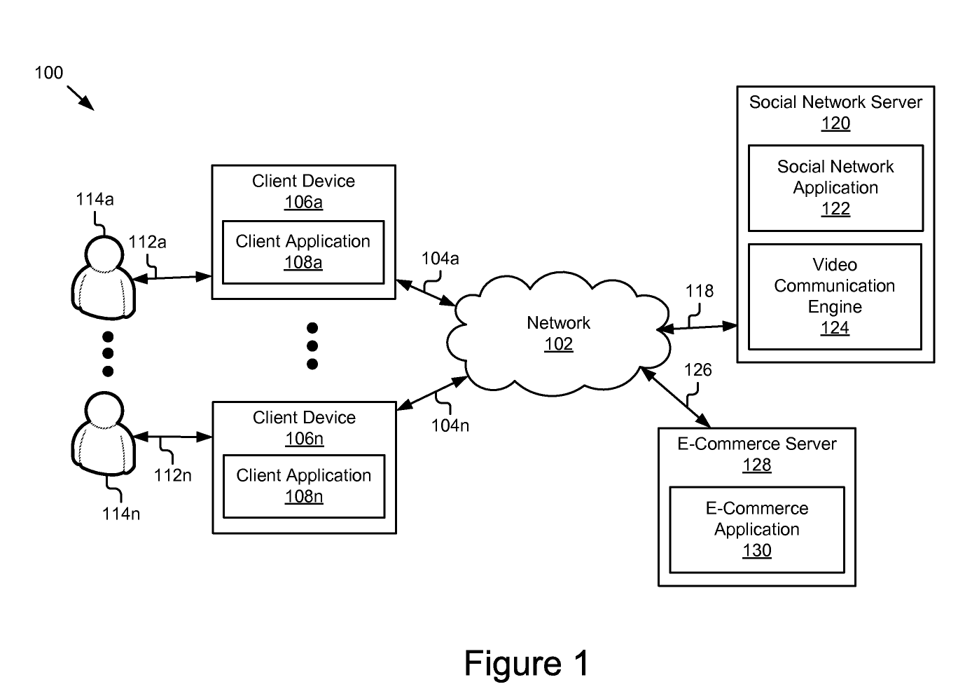

FIG. 1 is a block diagram of an example system 100 for purchasing a product in a video communication session. The illustrated system 100 includes client devices 106a . . . 106n (also individually or collectively referred to herein as 106) that can be accessed by users 114a . . . 114n (also individually or collectively referred to herein as 114), a social network server 120, and an e-commerce server 128, which are communicatively coupled via a network 102.

As depicted in FIG. 1, the social network server 120 and the e-commerce server 128 are respectively coupled to the network 102 via signal lines 118 and 126, for interaction and communication with each other and the other components of the system 100. The social network server 120 and the e-commerce server 128 may include one or more computing devices having one or more processors and one or more storage devices storing data or instructions for execution by the one or more processors. For example, the one or more computing devices may include a hardware server, a server array, enterprise storage, or any other computing device, or group of computing devices, having data processing, storing and communication capabilities. The one or more computing devices may also include a virtual server (i.e., a virtual machine) implemented via software. For example, the virtual server may operate in a host server environment and accesses the physical hardware of the host server including, for example, a processor, memory, storage, network interfaces, etc., via an abstraction layer (e.g., a virtual machine manager). It should be understood that any of the entities of the system 100 can be stored in any combination of devices and servers or in one device or server.

In some implementations, the entities of the system 100 may use a cloud-based architecture where one or more computer functions or routines are performed by remote computing systems and devices at the request of a local computing device. For example, a client device 106 may be a computing device having a limited set of hardware and/or software resources and may access hardware and/or software resources provided across the network 102 by other computing devices and resources, including, for instance, other client devices 106, the social network server 120, the e-commerce server 128, or any other entities of the system 100. In some instances, the social network server 120, the e-commerce server 128, or any other entity of the system 100 may be a cloud-based, distributed computing system having dynamically scalable and virtualizable resources, and various functionality of the social network server 120, the social network application 122, the video communication engine 124, the e-commerce server 128, the e-commerce application 130, or any other entity of the system 100 may be implemented and supplemented by computing systems and devices distributed over the network 102.

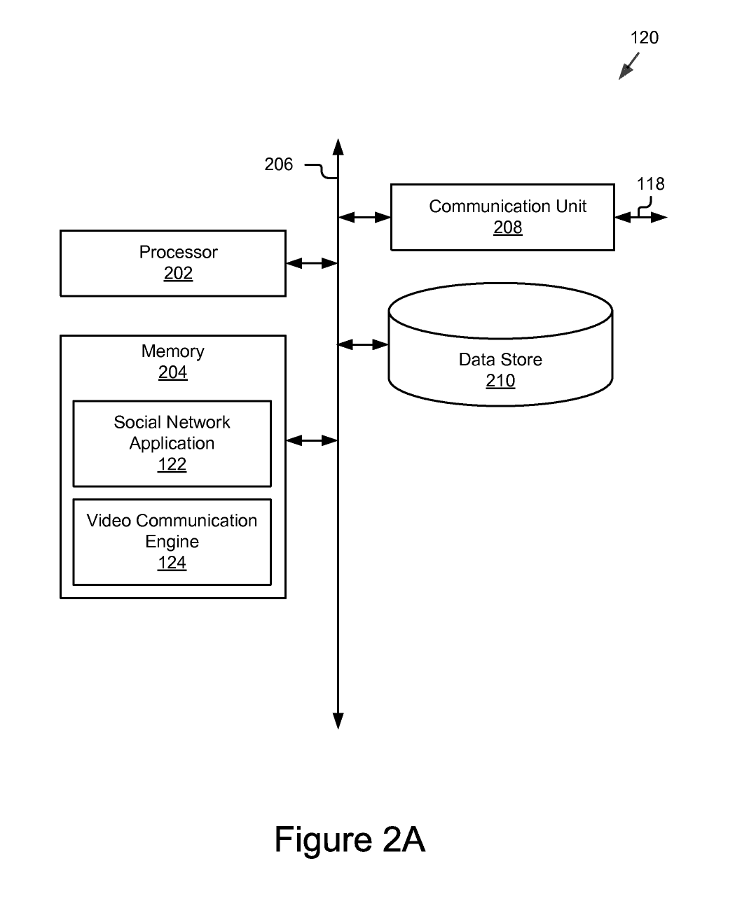

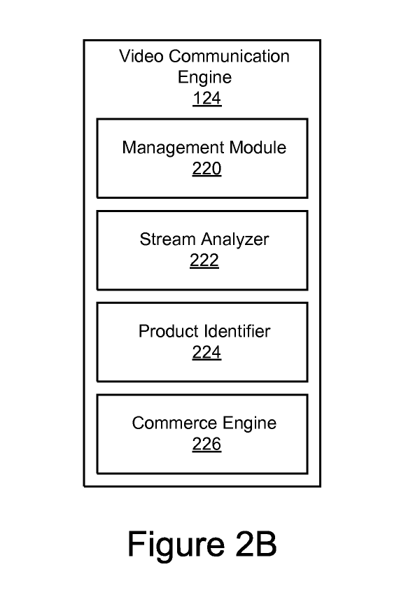

As depicted in FIG. 1, the social network server 120 includes a social network application 122 and a video communication engine 124, and the e-commerce server includes 128 an e-commerce application 130. The social network application 122 is operable to provide functionality for a social networking service (also referred to as a social network) and the video communication engine 124 is operable to cooperate with the social network application 122 to provide multi-user video communication functionality to the members of the social network and the ability to identify and purchase products displayed during a real time video communication session conducted via the video communication engine 124. Additional structure and functionality of the social network application 122 and the video communication engine 124 are further described below with reference to at least FIGS. 2A and 2B.

The e-commerce application 130 is operable to provide an e-commerce marketplace for various products and may store and provide access to product information (e.g., images, descriptions, categories, specifications, reviews, ratings, retailers, etc.) in a data store (not shown), such as one that is the same as or substantially similar to the data store 210. The e-commerce application 130 can provide a price comparison service that allows users to search for and compare prices of products available on the marketplace. The e-commerce application 130 may process payment, and place and provide for order fulfillment of products included available via the marketplace, or may redirect users to software applications (e.g., websites) of other online retailers to complete and process product purchases.

The other entities of the system 100 may interact with the e-commerce application 130 to access information about products accessible via the marketplace. In some implementations, the e-commerce application 130 may include a search engine for retrieving results from a data store that match one or more search criteria. In some instances, the search criteria may include an image of an object and the search engine may compare the image to images of products stored in its data store (not shown) to identify a product that matches the image. In a further example, the video communication engine 124 may signal the e-commerce application 130 to provide information that matches an object (e.g., image) that it has extracted from a video stream.

The entities 120 and/or 128 may require users to register a user account to access various functionalities and services provided by them. For example, to register, a credential module included in and operated by a given entity of the system 100 may require a user 114 to provide identifying information, for example, a valid electronic mail address and password, and the application may test the validity of the electronic mail address by sending the a confirmation message to the address containing instructions for confirming the account (e.g., selecting a hyperlink to a confirmation webpage operated by the service provider). Once registered, the credential module may require a user 114 seeking access to the service operated by this entity to authenticate by inputting the identifying information in an associated user interface.

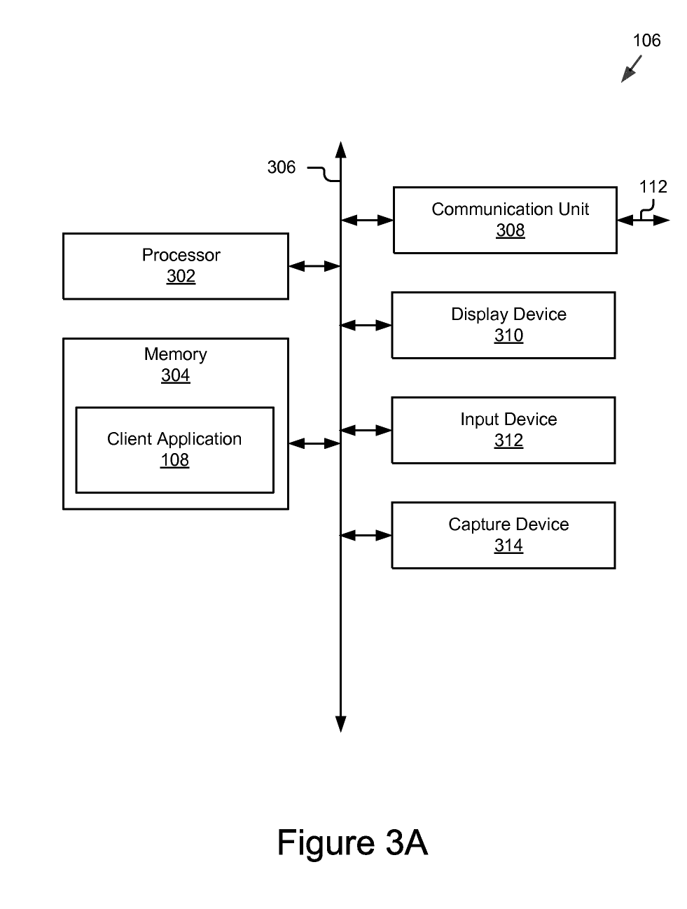

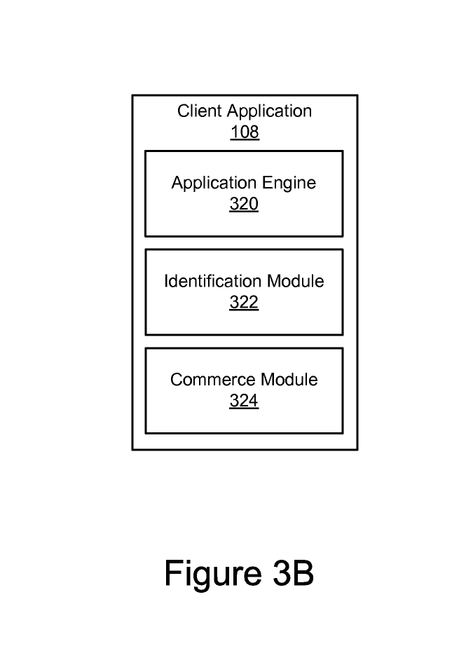

The client devices 106a . . . 106n are computing devices that are operable by users 114 and have data processing and communication capabilities. In the depicted implementation, the client device 106a is coupled to the network 102 via signal line 104a, and the user 114a's interactions with client device 106a are depicted by line 112a; and the client device 106n is coupled to the network 102 via signal line 104n, and the user 114n's interactions with the client device 106n are depicted by line 112n. In the depicted implementation, the client devices 106a . . . 106n respectively contain instances 108a and 108n of a client application 108, which are executable by a processor (see FIG. 3A) of the client devices 106a . . . 106n to provide for user interaction, and to send and receive data via the network 102. While FIG. 1 illustrates at least two client devices 106, the present disclosure applies to any system architecture having any number of client devices 106.

Examples of client devices 106 include, but are not limited to, a workstation computer, a desktop computer, a laptop computer, a netbook computer, a tablet computer, a smartphone, a set-top box/unit, an Internet Protocol-connected smart TV including a computer processor capable of receiving viewer input, accessing video content on computer networks (e.g., the Internet), and executing software routines to provide enhanced functionality and interactivity to viewers, or the like. The client devices 106a . . . 106n may include the same or different types of computing devices. For example, the client device 106a may be a laptop and the client device 106n may be a tablet computer. In some implementations, the client device 106 may be a handheld wireless computing device, which is capable of sending and receiving cellular voice and/or data communications. Additional structure and functionality of the client devices 106 are further discussed below with reference to at least FIGS. 3A and 3B.

The network 102 is a network for interconnecting computing nodes. The network 102 may have any number of configurations or topologies. By way of example, the network 102 may include a local area network (LAN), a wide area network (WAN) (e.g., the Internet), a mobile (cellular) network including distributed radio networks and a hub providing a wireless wide area network (WWAN), Bluetooth® communication networks, WiMAX® network, and/or any other interconnected data path across which multiple devices may communicate. The network 102 may transmit data using a variety of different communication protocols including, for example, various Internet layer, transport layer, or application layer protocols. For example, the network 102 may transmit data using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Client devices 106 may couple to and communicate via the network 102 using a wireless and/or wired connection. In some implementations, the client devices 106 include a wireless network interface controller for sending and receiving data packets to an access point of the network 102. For example, the client devices 106 may be Wi-Fi™ enabled devices which connect to wireless local area networks (WLANs), including, for example, wireless hotspots, included in the network 102. The client devices 106 may also include one or more wireless mobile network interface controllers for sending and receiving data packets via a WWAN of the network 102.

It should be understood that the system 100 illustrated in FIG. 1 is representative of an example system for purchasing a product in a video communication session, and that a variety of different system environments and configurations are contemplated and are within the scope of the present disclosure. Other implementations may include additional or fewer computing devices, services, and/or networks. Further, various entities of the system may be integrated into to a single computing device or system or additional computing devices or systems. For instance, other servers providing social networks, video communication services, e-commerce solutions, etc., may be included in the system. Additionally, the social network application 122 and/or the video communication engine 124 may be incorporated and implemented client-side in a peer-to-peer configuration without departing from the scope of the present disclosure.

FIG. 2A is a block diagram an example of a social network server 120. The social network server 120, as depicted, includes a processor 202, a memory 204, a communication unit 208, and a data store 210. The components of the social network server 120 are communicatively coupled by a bus 206. The social network server 120 depicted in FIG. 2A is provided by way of example and it should be understood that it may take other forms and include additional or fewer components without departing from the scope of the present disclosure. For example, while not shown, the social network server 120 may include input and output devices (e.g., a computer display, a keyboard and mouse, etc.), various operating systems, sensors, additional processors, and other physical configurations. Additionally, it should be understood that the computer architecture depicted in FIG. 2A could be applied to the other entities of the system 100 with various modifications. For example, the e-commerce server 128 could have the same or a similar architecture as the social network server 120 depicted in FIG. 2A, including, for instance, the processor 202, the memory 204, the communication unit 208, and the data store 210 coupled via a bus 206.

The processor 202 includes an arithmetic logic unit, a microprocessor, a general-purpose controller, or some other processor array to perform computations and provide electronic display signals to a display device (not shown). The processor 202 may be coupled to the bus 206 for communication with the other components of the social network server 120. The processor 202 may process data signals and may have various computing architectures including a complex instruction set computer (CISC) architecture, a reduced instruction set computer (RISC) architecture, or an architecture implementing a combination of instruction sets. Although only a single processor 202 is shown in FIG. 2A, multiple processors may be included and each processor may include a single processing core or multiple interconnected processing cores. The processor 202 may be capable of supporting the display of images, capturing and transmitting images, performing complex tasks, including various types of feature extraction and sampling, etc.

The memory 204 stores instructions and/or data that may be executed by the processor 202. In the depicted implementation, the memory 204 stores at least the social network application 122 and the video communication engine 124. The memory 204 is also capable of storing other instructions and data, including, for example, an operating system, hardware drivers, other software applications, databases, etc. The memory 204 is coupled to the bus 220 for communication with the processor 202 and the other components of social network server 120. The instructions and/or data may include code for performing any and/or all of the techniques described herein. The memory 204 includes a non-transitory computer-usable (e.g., readable, writeable, etc.) medium, which can be any apparatus or device that can contain, store, communicate, propagate or transport instructions, data, computer programs, software, code, routines, etc., for processing by or in connection with the processor 202. A non-transitory computer-usable storage medium may include any and/or all non-transitory computer-usable storage media. In some implementations, the memory 204 may include volatile memory, non-volatile memory, or both. For example, the memory 204 may include one or more of a dynamic random access memory (DRAM) device, a static random access memory (SRAM) device, flash memory device, a discrete memory device (e.g., a PROM, FPROM, ROM), a hard disk drive, a floppy disk drive, an optical disk drive (CD, DVD, Blue-Ray™, etc.), and/or any other mass storage device known for storing information on a temporary or more permanent basis. It should be understood that the memory 204 may be a single device or may include multiple types of devices and configurations.

The bus 206 can include a conventional communication bus for transferring data between components of a computing device or between computing devices, a network bus system including the network 102 or portions thereof, a processor mesh, a combination thereof, etc. In some implementations, the social network application 122 and the video communication engine 124 and it's sub-components 220, 222, 224, and 226, and various other software operating on the social network server 120 (e.g., an operating system, device drivers, etc.) may cooperate and communicate via a software communication mechanism implemented in association with the bus 206. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 208 is coupled to the network 102 by the signal line 118 and coupled to the bus 206. In some implementations, the communication unit 208 includes one or more network interface devices (I/F) for wired and wireless connectivity with the network 102. For example, the communication unit 208 may include a CAT-type interface, USB interface, or SD interface, transceivers for sending and receiving signals using Wi-Fi™, Bluetooth®, cellular communications, etc., or the like. The communication unit 208 can link the processor 202 to the network 102 that may in turn be coupled to other processing systems. The communication unit 208 can provide other connections to the network 102 and to other entities of the system 100 using various standard communication protocols, such as those discussed above with reference to the network 102.

The data store 210 is information source for storing and providing access to information including, for example, social network content, social graph information, product information, analysis data, request information, etc. The data store 210 can include one or more non-transitory computer-readable mediums. In some implementations, the data store 210 is coupled for communication with the various components 122, 124, 202, 204, 208, 210, 220, 222, 224, and 226 of the social network server 120. In some implementations, the data store 210 stores product information, product analysis and identification information, analysis improvement and optimization data, purchase history, redirect history, identification request history, video communication session history and information, social network content, information received from the other entities 106 and 128 of the system 100, and the like. While the data store 210 is depicted in FIG. 2A as being included in the social network server 120, it should be understood that it may be included in another computing device and/or storage system distinct from but coupled to or accessible by the social network server 120.

In some implementations, the social network application 122, the video communication engine 124, the management module 220, the stream analyzer 222, the product identifier 224, and the commerce engine 226 are coupled to the data store 210 via the bus 206 to manipulate, i.e., store, query, update and/or delete data included in the data store 210 using programmatic operations. In some implementations, the data store 210 includes a database management system (DBMS) operable on the social network server 120. For example, the DBMS could be a structured query language (SQL) DBMS and/or a NoSQL DMBS. In another example, the DBMS may store data in multi-dimensional tables comprised of rows and columns, and manipulate, i.e., insert, query, update and/or delete, rows of data using programmatic operations.

The social network application 122 is software, code, logic, or routines for providing a social network. A social network is any type of social structure where the users 114 are connected by one or more common features. The common features can include any attribute, interest, preference, or interaction attributable to the users 114. For example, the common features include relationships/connections, e.g., professional and academic attributes and interests, friendships, familial ties, etc. The common features can also include explicitly defined relationships and relationships implied by social connections with other online users and entities. The common features can be provided by one or more social networking systems, including, for example, those included in the system 100. In some implementations, the common features are derived from the users' user profiles stored in one or more information sources associated with these social networking systems. A user's user profile can include information specific to that user like personal information, professional information, and interaction data reflecting the user's activity on the social network. For example, the personal information may describe where a user lives, the user's hobbies, relationship status, gender, age, biographical information, etc.; the professional information may describe a user's professional experience and qualifications (e.g., employment history, job title, skills and certifications, education, etc.); and the social network activity may describe a user's content stream posts including content submissions, notifications, messages, comments, positive or negative endorsements for various content posted by other users, etc. Common features between the personal information, professional information, and social network activity of the users can be mapped by the social network application 122 to connect the users.

Each individual user's relationships and connections with other users and entities, explicit or implicit, may form a social graph for that user. For example, a user's social graph may include social graph connection information describing connections between that user and the other users of the social network; what common features, attributes, interests, social network activity, etc., connect that user to other users; any groups/sets formed by that user and/or the social network application 122 to categorize or group his or her connections on the social network; the strength of the connections between the user and other users, which can be calculated based on, for example, the degree or degrees (e.g., 1st, 2nd, 3rd, 4th, etc.) of separation between the user and other users, who, if any, the connecting/interstitial users are; the amount or type of interactions between the users, etc.; etc. For instance, the social network application 122 and/or a user (e.g., via an associated user interface), may define groups for users who are work friends, school friends, networking contacts, clients, etc., and user's the social graph may include data reflecting what groups these users belong to.

Together, the social graphs of the users may form a collective social graph that reflects a mapping of all of the users of the social network and how they are related, which may be stored in and accessed via an information source, such as the data store 210. For instance, the data store 210 can store, manage and provide access to the information connecting the users of the social network, including social graph information, information describing the common features connecting the users the social network, user profile information, etc. The social network application 122, the video communication engine 124, and the other entities of the system 100 can interact with the data store 210 to manipulate (e.g., insert, query, update, and/or delete) this information using programmatic operations.

The video communication engine 124 is software, code, software, and routines for managing a multi-user video communication session, which may be used by the users to communicate and interact with one another and may analyze the video streams of the session for products and identify them to the users for them to investigate and purchase. In some instances, the video communication engine 124 may manage the establishment of video communication session between a plurality of conferencing nodes 124, receive and send management data to and from the conferencing nodes (e.g., client devices 106), and be capable of receiving, combining, splitting, muting, analyzing, manipulating, and sending video streams including audio, video, rich media, images, text, overlays, metadata, embedded data, etc., to and from the conferencing nodes.

As depicted in FIG. 2B, the video communication engine 124 may include a management module 220, a stream analyzer 222, a product identifier 224, and a commerce engine 226. The components 220, 222, 224, and 226, and the video communication engine 124 itself, may be communicatively coupled to one another and/or the other components 122, 202, 204, 208, and 210 of the social network server 120. For example, the video communication engine 124 or its components 220, 222, 224, and 226 can interact with the social network application 122 to authenticate users seeking access to the video communication engine 124, and to provide the video communication engine 124 access to information and functionality of the social network application 122 and its social graph.

The management module 220 is software, code, software, and routines for managing video communications sessions between a plurality of conferencing nodes. In some embodiments, the management module 220 manages a video communication session by receiving video streams from the conferencing nodes participating in the video session, generating video communication session streams that include the inbound data streams, and transmitting the video communication data streams to the conferencing nodes. The video streams being received from the conferencing nodes are referred to in reference to the management module 220 as inbound video streams. The management module 220 may be coupled to the communication unit 208 via the bus 206 to receive the inbound data streams and send the video communication data streams.

To form a video communication session, the management module 220 may, in some embodiments, receive a request from a user inviting other users to participate in the session. The management module 220 may relay the invitations to the other users and wait for them to respond by transmitting data providing consent to participate in the session back to the management module 220. Once accepted, the management module 220 may receive inbound video streams from these users, which are captured real-time by a capture device 314 (e.g., video camera) (see FIG. 3A) included in or coupled to the client devices 106 of the users 114, and provided to the management module 220 for distribution to the other users of the session.

The management module 220 may generate each of the video communication session streams to include audio-video data received from each of the conferencing nodes other than the conferencing node for which that video communication session stream is designated. For example, in a video conference with users 114a, 114b, and 114n, the video communication session stream generated for user 114a may include data from the inbound video streams (e.g., audio-video data streams) captured and provided by users 114b and 114n, the video communication session stream generated for user 114b may include data from the inbound video data streams captured and provided by users 114a and 114n, and the video communication session stream generated for user 114n may include data from the inbound video data streams captured and provided by users 114a and 114b. In other embodiments, the video conferencing nodes receive the same video communication session stream generated by combining the inbound video streams received from those nodes.

When generating the video communication session streams, the management module 220 may combine two or more inbound data streams into a container file to encapsulate data streams. In some embodiments, the container encapsulates and organizes the synchronous communication data streams using metadata so they can later be decoded and presented by the client application 108 operating on a client device 106. In some embodiments, the management module 220 may transmit the video communication session stream to the participating conferencing nodes using a multicast delivery system, which may utilize optimal data transmission paths for the most efficient delivery of the data streams to the participating conferencing nodes. In other embodiments, the management module 220 transmits the video communication session stream using a unicast or anycast delivery system.

In some embodiments, the management module 220 may manipulate the data streams it manages. For example, the inbound video streams may include a container containing audio-video data, which the management module 220 can un-package, decompress, compress, transcode, etc., into various formats to generate the video communication session stream. The transcoding performed by the management module 220 may be lossy or lossless and may convert the encoding of the synchronous communication data streams from any format to any other format using various known audio and video codecs. Example audio codecs and formats include ACC, MP3, Vorbis, etc., and example video codecs and formats include MPEG-4, H.264, Theora, VP8, etc. The container file used by the management module 220 may package the synchronous communication data streams or data streams, such as audio-video data streams, included in the synchronous communication data streams in any known format including FLV, WebM, ASF, ISMA, etc. In other embodiments, the transcoding may be performed by other modules of the video communication engine 124 or may be performed by other entities of the system 100 such as the conferencing nodes.

During a video communication session, various products may be displayed to the users in their respective video communication session streams. A product may, in some cases, be explicitly included for viewing and evaluation by one or more users of the session. By way of example, a retailer may initiate a video communication session for other users to join and view the products that they are selling. In this example, the retailer may pan through a series of different products for the other users to evaluate. In other cases, a product may be included by virtue of being in the field of view of a user's capture device 314. For instance, a user's clothes, accessories, or other items in a user's immediate area may be included in the video stream provided to the other user(s) of the video communication session.

The stream analyzer 222 is software, code, logic, or routines for analyzing the video streams of video communication sessions in real time for product-like objects that may be purchasable and the product-identifier 224 is software, code, logic, or routines for confirming whether one or more objects are purchasable products and determining and providing information about the purchasable products. The stream analyzer 222 is capable of analyzing a video stream, which has been previously unanalyzed for the objects it contains, and identifying any objects depicted by it in real time. The stream analyzer 222 may analyze the inbound video streams or the video communication session streams that include the inbound video streams. It should be understood that while the stream analyzer 222 and the product identifier 224 are depicted in FIG. 2B as distinct entities, in other embodiments, they may be combined into a single entity, combined with other entities, or further divided into additional entities without departing from the scope of this disclosure.

In some embodiments, the stream analysis algorithm used by the stream analyzer 222 to analyze a video stream may decompose the video data included in the stream into shapes or data points and determine, based on those shapes or data points, which of them represent animate objects and which of them represent inanimate objects. For instance, the stream analysis algorithm may recognize humans, animals, other living objects and eliminate from consideration while preserving the clothes, accessories, etc., adorning the living objects for further identification. The inanimate objects may be provided to the product identifier 224 for it to use to confirm whether the inanimate are identifiable as products and purchasable. In some embodiments, the stream analysis algorithm may extract an image of each inanimate object and provide the image to the product identifier 224 for it to use when performing its functionality.

The stream analyzer 222 is capable of improving the accuracy and speed of its analysis over time. In some embodiments, the stream analyzer 222 may “learn” which objects product-like based on feedback provided to the stream analyzer 222 by the product identifier 224 about the objects it processes to eliminate re-processing of objects by the product identifier 224 that are unlikely to be products. For instance, if, over a series of iterations, an object is routinely confirmed by the product identifier 224 to not be a product, the stream analyzer 222 can filter out this object from future confirmation requests to the product identifier 224. As a further example, the stream analyzer 222 and/or the product identifier 224 can maintain a database of objects (e.g., in the data store 210) to be filtered out and the stream analyzer 222 can query this database to determine whether an object should be passed along to the product identifier 224 for confirmation. Conversely, objects that are routinely confirmed as products by the product identifier 224 may be stored in a database (e.g., in the data store 210) and referenced at analysis time to quickly and efficiently determine them as products when they re-appear in future video communication sessions.

The stream analyzer 222 and/or product identifier 224 are capable of using user behavior and interaction to optimize which products to identify as purchasable. For instance, based on user interaction with the products identified via the client application 108 as purchasable, the stream analyzer 222 can determine which objects/products appear frequently, are popular, are regularly investigated and purchased, etc., and may use this information to determine which products to provide product data for. Evidence of such may be stored by the commerce engine 226, the management module 220, or another component of the video communication engine 124 in the data store 210 for reference by the stream analyzer 222 and/or product identifier 224.

In some embodiments, the stream analyzer 222 performs its analysis responsive to receiving an identification request from the client device 106 of a user 114 participating in the video communication session. In other embodiments, the stream analyzer 222 performs its analysis automatically/autonomously. The stream analyzer 222 can receive the video streams it analyzes via the management module 220, receive them from another component of the video conferencing engine 124, such as a handler or controller module, or receive them from the client devices 106 or another entity of the network 102.

In the depicted embodiment, the stream analyzer 222 and product identifier 224 cooperate to identify purchasable products in a video stream. For instance, upon analyzing a video stream and identifying one or more product-like objects included by it, the stream analyzer 222 may send an identification signal to the product-identifier 224 signaling it to determine the identities of the one or more objects and confirm whether they are purchasable. The identification signal may include information describing the objects, such as images of the objects extracted from the video streams by the stream analyzer 222 or electronic references to those images. In other embodiments, another module, such as a controller (not shown) or the management module 220, may signal the stream analyzer 222 and product identifier 224 to perform their respective functionalities and provide them with any necessary data to do so.

To confirm an object as a purchasable product, the product identifier 224 may compare the object to image and/or video objects stored in a product database. The product identifier 224 may perform this functionality responsive to receiving the identification signal from the stream analyzer 222. In some embodiments, the product identifier 224 may query a local product database, such as one included in the data store 210, a remote product database, a combination of the foregoing, etc., for products matching the object. For example, the product identifier may perform the query using another component of the system, such as a search engine operated by a search server (not shown) coupled to the network 102, or the e-commerce application 130 operable by the e-commerce server 128. In some instances, the query may be an image-based query. As a further example, the product identifier 224 may provide an image depicting the object to the search engine, may receive a list of URIs and information related to the image, and may further aggregate information about the object from computing devices (e.g., servers) associated with the URIs. In another example, the social network server 120 may include an aggregator that aggregates product information for numerous products from computing devices coupled to the network 102, such as the e-commerce application 130, and stores the information in the data store 210. For instance, the social network server 120 may include a web crawler that crawls the Internet for content hosted by e-commerce websites and stores an instance of that content, including product information, in the product database.

The product identifier 224 may determine product information for the objects it confirms as products. In some embodiments, the product information may be retrieved from one or more of the product database and information sources, such as the search engine or the e-commerce server 128, coupled to the network 102. The product data may include any information that describes or is associated with the product. For instance, the product information may include one or more of a product title, a product description, product specifications and features, images of the product, product ratings and reviews, recommendations for the product, items related to the product, seller information, pricing information, comparison shopping information, shipping information, social network activity related to the product (e.g., number of times the product was shared, endorsed, posted about, etc.), and the like.

Once one or more objects have been confirmed as products, product data for the product(s) may be transmitted to one or more of the client devices 106 of the video communication session for presentation. The product identifier 224 may transmit this data to the one or more client devices 106 or may provide it to the stream analyzer 222 or the management module 220 for transmission to the one or more client devices 106. The product data may identify whether any products where found, and if so, may include location information describing the location of the products/objects within the video communication session stream and any product information determined by the product identifier 224. In some embodiments, the location information may describe the location of the products/objects within the video communication session stream relative to the boundaries of the video frame(s).

The commerce engine 226 is software, code, logic, or routines for enabling users to the purchase the purchasable products. In some embodiments, the commerce engine 226 enables user to purchase a purchasable product by providing comparison shopping functionality to the user purchasing the product, which the user can use to further investigate the product, compare prices from various retailers, and select a retailer from which to purchase the product. Upon doing so, the commerce engine 226 may redirect the user to that retailer's electronic storefront to finalize the purchase of that product. For instance, the commerce engine 226 may send a redirect instruction to the client application 108 redirecting it to interact with an application hosted by the retailer, such as the e-commerce application 130.

In other embodiments, the commerce engine 226 may enable users to purchase a product by operating as an online storefront and selling the product to the user directly. For instance, the commerce engine 226 may process payment for a product and place the order for the product. In some instances, the commerce engine 226 may also be capable of managing order fulfillment, such as managing logistics and providing tracking and shipping information to the purchaser of the product. In this embodiment, the commerce engine 226 may maintain the product information for the products it sells in the data store 210.

In some implementations, one or more of the components 122, 124, 220, 222, 224, and 226 are sets of instructions executable by the processor 202 to provide their functionality. In other implementations, one or more of the components 122, 124, 220, 222, 224, and 226 are stored in the memory 204 of the social network server 120 and are accessible and executable by the processor 202 to provide their functionality. In any of the foregoing implementations, these components 122, 124, 220, 222, 224, and 226 may be adapted for cooperation and communication with the processor 202 and other components of the social network server 120. For instance, the components 122, 124, 220, 222, 224, and 226 may be sets of instructions stored in the memory 204 and executable by the processor 202 for communication with the other components of the social network server 120; may be implemented via one or more application specific integrated circuits (ASICs) coupled to the bus 206 for cooperation and communication with the other components of the social network server 120; sets of instructions stored in one or more discrete memory devices (e.g., a PROM, FPROM, ROM) that are coupled to the bus 206 for cooperation and communication with the other components of the social network server 120; a combination thereof; etc.

It should be understood that the embodiment depicted by FIGS. 2A and 2B is provided by way of example, that that numerous other embodiments are possible, contemplated, and within the scope of the present disclosure. For instance, the video communication engine 124 may be stored and operable on a third-party server (not shown) which is coupled by the network 102 for communication and interaction with the social network server 120, the social network application 122 and its social graph. In this example, the video communication engine 124 may access information and utilize the functionality of the social network application 122 via an API.

FIG. 3A is a block diagram of an example client device 106. As depicted, the client device 106 includes a processor 302, a memory 304, a communication unit 308, a display device 310, an input device 312, and a capture device 314, which are communicatively coupled by a bus 306. However, it should be understood that the client device 106 is not limited to such and may also include other elements, such as one or more of a power source; a graphics processor; a virtual and/or physical keyboard; forward and rear facing cameras; sensors like accelerometers and/or gyroscopes; a GPS receiver; a Bluetooth® module; memory storing applicable firmware; and various physical connection interfaces (e.g., USB, HDMI, headset jack, etc.); an operating system for managing the hardware and resources of the client device 106; application programming interfaces (APIs) for providing applications access to the hardware and resources; and various applications including, for example, applications for making phone calls, video calls, web browsing, messaging, social networking, gaming, capturing digital video and/or images, etc., which may be stored and operable on the client device 106.

The processor 302 includes an arithmetic logic unit, a microprocessor, a general-purpose controller, or some other processor array to perform computations and provide electronic display signals to the display device 310. The memory 304 stores instructions and/or data that may be executed by the processor 302, including, for example, the client application 108. The memory 304 is coupled to the bus 306 for communication with the other components. The communication unit 308 transmits and receives data to and from at least one of the client device 106, the social network server 120, and the e-commerce server 128. The communication unit 308 is coupled to the bus 306. The processor 302, the memory 304, and the communication unit 308 include features, structure, and functionality that are substantially similar to or the same as the processor 202, the memory 204, and the communication unit 208, respectively, and the description provided for those entities will not be repeated here in the interest of brevity.

The display device 310 includes any device equipped to display video streams, electronic images, and data as described herein. The display device 310 may be any a conventional display device, monitor or screen, such as an organic light-emitting diode (OLED) display, a liquid crystal display (LCD), etc. In some instances, the display 310 is a touch-screen display capable of receiving input from one or more fingers of a user 114. For example, the display device 310 may be a capacitive touch-screen display capable of detecting and interpreting multiple points of contact with the display surface.

The input device 312 is any device for inputting data on the client device 106. In some embodiments, the input device 312 is a touch-screen display capable of receiving input from the one or more fingers of the user 114. The functionality of the input device 312 and the display device 310 may be integrated, and a user 114 of the client device 106 may interact with the client device 106 by contacting a surface of the display device 310 using one or more fingers. For example, the user 114 interacts with an emulated (i.e., virtual or soft) keyboard displayed on the touch-screen display device 310 by using fingers to contacting the display in the keyboard regions. In other embodiments, the input device 312 is a separate peripheral device or combination of devices. For example, the input device 312 includes a keyboard (e.g., a QWERTY keyboard) and a pointing device (e.g., a mouse or touchpad). The input device 312 may also include a microphone or other similar capture device.

The capture device 314 is a digital image capture device capable of capturing audio and video. In some instances, the capture device 314 may also capture still images. The capture device 314 may be integrated with the client device 106 or coupled to the bus 306 via an I/O port. The capture device 314 is coupled to the bus 306 and accessible to other components of the client device 106. In some embodiments, the capture device 314 may include a lens for gathering and focusing light, a photo sensor including pixel regions for capturing the focused light and a processor for generating image data based on signals provided by the pixel regions. The processor may be integrated with the processor 302 of the client device 106 or may be separate therefrom. In some embodiments, the processor of the capture device 314 is coupled via the bus 306 to store image data in the memory 304. The photo sensor may be any type of photo sensor including a charge-coupled device (CCD), a complementary metal-oxide-semiconductor (CMOS) sensor, a hybrid CCD/CMOS device, etc. The capture device 314 may include a microphone (not shown) for capturing sound or may be coupled to a microphone included in another component of the client device 106 or coupled to the bus 306. The capture device 314 may also include other features such as a flash, zoom lens, etc. The client device 106 may include a driver (not shown) storable in the memory 304 and operable by the processor 302 to control/operate the capture device 314, and the components of the client device 106 may utilize the functionality of the capture device 314 via the driver.

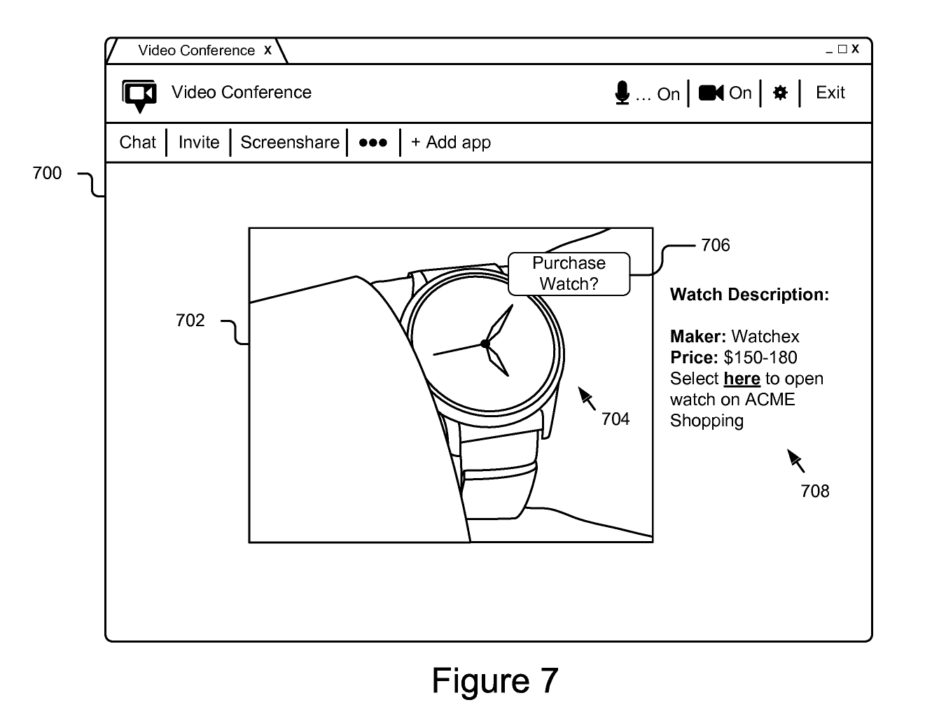

The client application 108 is software, code, logic, or routines for instructing a client device 106 to render user interfaces (e.g., the interface 700 depicted in FIG. 7) to present information including text, images, video and audio; engaging in video communication sessions; interacting with the capture device 314 to capture video of a user interacting with the client application 108; receiving user input; and sending information to and receive information from the social network server 120, the e-commerce server 128, or other entities of the system 100 via the network 102. In some embodiments, a user 114 may use the client application 108 operating on the user 114's client device 106 to identify a product being displayed in a video communication session the user 114 is participating in, investigate the product, and purchase the product. In some embodiments, the client application 108 may be client code operable as or by a web browser, a customized client-side application, a combination of both, etc.

FIG. 3B is a block diagram of an example client application 108. As depicted, the client application 108 includes an application engine 320, an identification module 322, and a commerce module 324. However, it should be understood that other implementations are contemplated and within the scope of this disclosure. For example, the application engine 320, the identification module 322, and the commerce module 324 may be integrated or further divided into additional components.

In some implementations, one or more of the components 108, 320, 322, and 324 are sets of instructions executable by the processor 302 to provide their functionality. In other implementations, one or more of the components 108, 320, 322, and 324 are stored in the memory 304 of the client device 106 and are accessible and executable by the processor 302 to provide their functionality. In any of the foregoing implementations, these components 108, 320, 322, and 324 may be adapted for cooperation and communication with the processor 302 and other components of the client device 106. For instance, the components 108, 320, 322, and 324 may be sets of instructions stored in the memory 304 and executable by the processor 302 for communication with the other components of the client device 106; may be implemented via one or more application specific integrated circuits (ASICs) coupled to the bus 306 for cooperation and communication with the other components of the client device 106; sets of instructions stored in one or more discrete memory devices (e.g., a PROM, FPROM, ROM) that are coupled to the bus 306 for cooperation and communication with the other components of the client device 106; a combination thereof; etc.

The application engine 320 is software, code, logic, or routines for sending, receiving, and processing information, and providing information to users for presentation and interaction. The application engine 320 may be coupled to the communication unit 308 to send and receive data to the other entities 120 and 128 coupled to the network 102. In some embodiments, the application engine 320 may generate and send a request to initialize a video communication session with one or more other users to the video communication engine 124; receive an invitation to join a video communication session from the video communication engine 124; prompt the user to accept the request and send acceptance thereof to the video communication engine 124; capture a video stream (e.g., of the user(s), product(s), etc.) via the capture device 314; transmit the video stream to the video communication engine 124 for distribution to the other users of the video communication session; present the video communication session to the user, which includes the video streams provided by the other users participating in video sessions; cooperate with the product identifier 224 to highlight any products included in the video communication sessions; and cooperate with the commerce engine 226 to process the sale of any products selected by the user.

The application engine 320 can generate and display user interfaces including, for example, the interface 700 depicted in FIG. 7. The application engine 320 may generate these user interfaces based at least in part on information received from the social network server 120 and/or the e-commerce server 128. For example, the user interfaces may include functionality for engaging in a video communication session, viewing and interacting with products identified during the video communication sessions, browsing information about those products, purchasing the products, etc.

The application engine 320 may be coupled to the input device 312 via the processor 302 and the bus 306 to receive input signals from the user 114. For example, a user 114 may select to invite one or more users to communicate via a video communication session, and during that session, may select to purchase or further research products depicted in the video communication session and highlighted to the user 114. The application engine 320 may receive signals from the input device 312 describing the user 114's selections and processes them accordingly. In some implementations, the user interfaces generated by the application engine 320 include user interface elements that allow the users 114 to input information and commands. For example, the user interfaces may include any combination of video display regions, text entry fields, selection boxes, drop-down menus, buttons, virtual keyboards and numeric pads, etc.

The application engine 320 may interact with the capture device 314 to obtain a real-time audio-video data stream (e.g., video stream) of the user 114, product(s), or any other object within the field of view of the capture device 314. For example, the application engine 320 can interface with the driver of the capture device 314 to interact with and control the functionality of the capture device 314 (e.g., a webcam, video camera, etc.). The application engine 320 and/or the capture device 314 may encoded the audio-video data stream being captured using various audio and video codecs and encapsulate it data into a container. The audio and video codecs and container formats may be open or proprietary, and may include any codecs and formats, such as those discussed above with reference to the management module 220. The application engine 320 may transmit the audio-video data stream being captured to the video conferencing engine 124 (e.g., management module 220) for distribution to the other users of the video communication session.

The identification module 322 is software, code, logic, or routines for analyzing video communication session video streams for purchasable products and determining product data for those products. To perform this functionality, in some embodiments, the identification module 322 is capable of interacting with the stream analyzer 222 and the product identifier 224. For example, the identification module 322 can send an identification request to the video communication engine 124 requesting that any purchasable products within view be identified. The stream analyzer 222 may receive the request, either directly or indirectly, and responsive thereto, may proceed to analyze the one or more streams of the video communication session for product-like objects and cooperate with the product identifier 224 to confirm that the objects are purchasable products and determine information for those products, as discussed in further detail elsewhere herein. In these embodiments, the analysis may be performed server-side and the identification module 322 may act as a facilitator.

In other embodiments, the some or all of the functionality of the stream analyzer 222 and/or the product identifier 224 may be integrated into the identification module 322. For instance, the identification module 322 may analyze the video streams of a video communication session client-side and interact with the product identifier 224 via the network 102 to confirm the objects and products and receive related information for those products. In another example, the identification module 322 may maintain an instance of the product database, for example, in the memory 304 or another data store, such as one substantially similar in functionality to the data store 210, and may perform the functionality of the product identifier 224 by using the product-like objects identified by it to confirm whether they represent purchasable objects and determining product information for the products that are.

In some embodiments, the identification module 322 analyzes the video communication session for products responsive to receiving user input commanding that any products within view be identified. For instance, a user participating in a video conference is presented with a video communication session stream (e.g., a combined video stream) that includes real-time video of the other users participating in the video conference, and the user, liking a watch being worn by one of the other users, selects an icon that is configured to instruct the identification module 322 to identify and provide information for the products (e.g., the watch) within view. In other embodiments, products included in the video communication session may automatically and persistently be identified by the video communication engine 124, as discussed elsewhere herein, and the identification module 322 may continuously receive product data for the objects coming in and out of the field of view during the video communication session and signal the application engine 320 to identify them to the viewing user(s).

The identification module 322 may use the product data determined for one or more purchasable products to highlight and display information about those products to the user. In some embodiments, the product data may include the location of a product relative to the boundaries of the frames of the video communication session stream and the identification module 322 may visually annotate the product, for example, by instructing the application engine 320 to highlight the product, display a user-selectable element in connection with the product, and display information about the product. By way of further example, the identification module 322 may identify to the user, in real-time, one or more purchasable products within view of the video communication session, present additional information about the product, and provide options for purchasing and/or shopping for the product. The product information, as discussed elsewhere herein, may include any information related to one or more products, including, but not limited to, images of the products, vendors selling the products, prices for the products, reviews of the products, links to additional information about the products, endorsements on the social network for the products, users connected to the viewing user on the social network that have used, reviewed, or purchased the products, etc.

The commerce module 324 software, code, logic, or routines for providing for the purchase of one or more selected products by enabling users to purchase selected products or cooperating with one or more entities coupled to the network 102 to enable the users to purchase the products. The commerce module 324 may receive input from the user (e.g., via the application engine 320, the input device 312, etc.) selecting to purchase or research the product, and the commerce module 324 may process the input accordingly.

In some embodiments, a user may select to research a product (e.g., read reviews, compare prices and/or competing products, etc.) and the commerce module 324 may redirect the user to a shopping service operated by the commerce engine 226 or the e-commerce application 130. For instance, the commerce module 324 may redirect the user to an application interface associated with the e-commerce server 128 or the commerce engine 226 (e.g., by opening a URI in a web browser via which the user can conduct research, compare prices, etc.).

In these or other embodiments, the product may be selected for purchase, and the commerce module 324 may redirect the user to an online storefront, such as one operated by the commerce engine 226 or the e-commerce application 130, to complete the sale. For instance, the commerce module 324 may process the sale in cooperation with the commerce engine 226 by prompting, via an interface displayed by the application engine 320, the user to confirm the sale and enter payment information, transmit the payment information to the commerce engine 226 for verification and processing, receive confirmation of payment, and provide the same to the user. In other examples, the commerce module 324 may perform some or all of the functionality of the commerce engine 226 and interact with a payment server (not shown) hosting a payment application for verifying and processing payment for the products being purchased. Other variations are also contemplated and within the scope of the present disclosure.

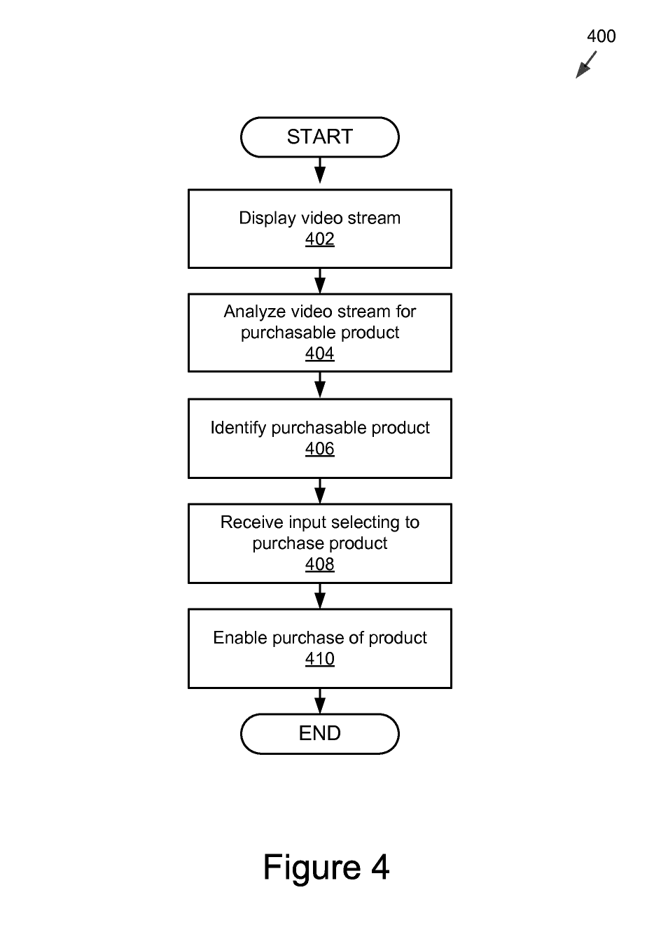

Additional structure and functionality of the video communication engine 124 and the client application 108 are further discussed below with reference to at least FIGS. 4-7.

FIG. 4 is a flowchart of an example method 400 for identifying and enabling the purchase of a product in a video communication session. The method 400 displays 402 a video communication session stream to a user, which includes one or more video streams of one or more other users participating in the video communication session. For example, the application engine 320 generates and displays a user interface, which includes video communication session stream and options for managing and interacting with the video communication stream. Next, the method 400 analyzes 404 the video communication session stream for one or more purchasable products. In some embodiments, the method 400 may analyze 404 the video communication session stream by requesting the video communication engine 124 identify and provide product data for the products depicted by the video communication session stream. In other embodiments, the method 400 may analyze 404 the video communication stream by detecting one or more product-like objects depicted by the video communication session stream and match those objects to a plurality of products stored in a product database to identify whether they are purchasable. For instance, the product database may store a plurality of media objects respectively associated with the plurality of products, and the method 400 may generate a media object (e.g., a graphical image) of a product-like object detected by it in the video communication session stream and compare the media object to the plurality of media objects to identify the purchasable product.

Next, the method 400 identifies 406 the purchasable product. In some embodiments, the method 400 identifies 406 the product by presenting a user-selectable element for carrying out a product-related action, such as purchase, shop for, or research the product. The method 400 then receives 408 input, such as a product selection, from the user selecting the purchase the purchasable product and, responsive thereto, the method 400 enables 410 the user to purchase the product. In some embodiments, the commerce module 324 can enable the user to purchase the product by processing the sale of one or more selected products, providing for comparison-shopping or research, etc., or cooperating with the social network server 120, the e-commerce server 128, or another entity coupled to the network 102 to provide this functionality. For instance, to enable the user to purchase the product, the method 400 may redirect the user to a shopping service operated by the commerce engine 226 or the e-commerce application 130.

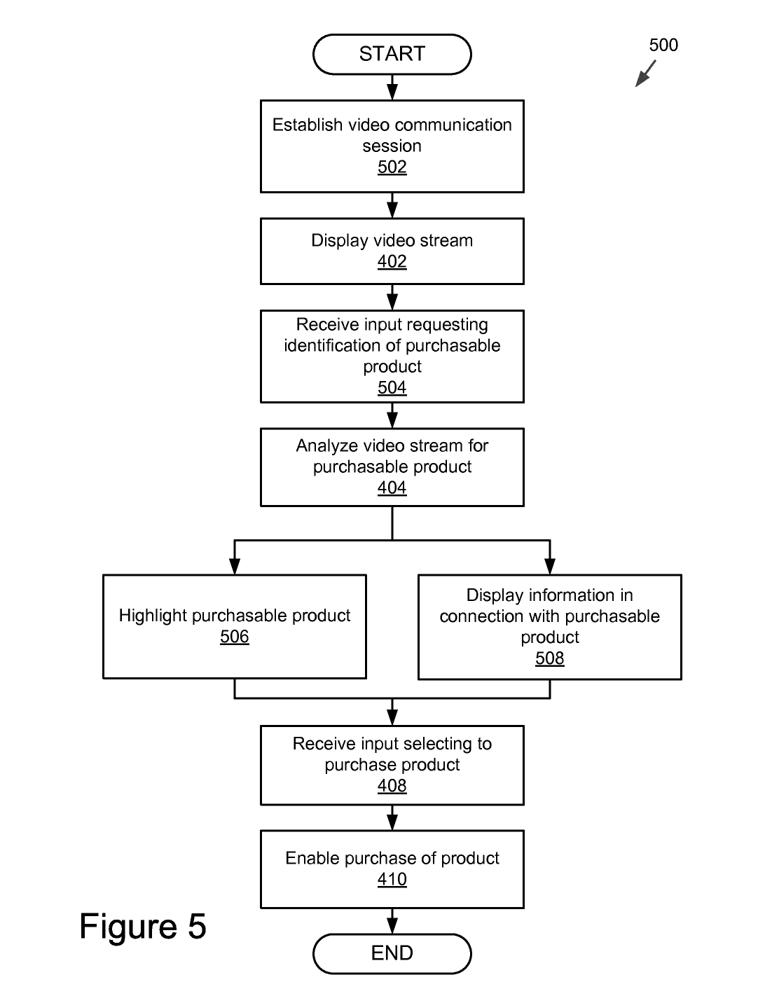

FIG. 5 is a flowchart of a further example method 500 for identifying and enabling the purchase of a product in a video communication session. As depicted in FIG. 5, the method 500 includes blocks that are the same as or substantially similar to the blocks of the method 400. For convenience and ease of understanding, those blocks have the same reference numerals and perform the same or substantially similar functions, and their description will not be repeated in full here.

In block 502, the method 500 establishes a video communication session. In some embodiments, the video communication session is established by sending a request to engage in the video communication session. For instance, the request may be an invitation for others to join the video communication session or an acceptance of an invitation to join the video communication session. As discussed above, the application engine 320 may interact with the video communication engine 124 to form and engage users in the video communication session. In association with the establishment of the video communication session, a video communication session stream is displayed 402 by the method 500 to a user participating in the video communication session.

Next, the method 500 receives 504 input requesting identification of a purchasable product and, responsive thereto, analyzes 404 the video communication session stream for a purchasable product. For instance, a user of the video communication session may select a user interface element requesting that all purchasable products within view be identified (e.g., highlighted). As a further example, a user can request that a purchasable product be identified to one or more other users participating in the video, all participating users, or to himself/herself. In other instances, this request may be generated autonomously (e.g., by the client application 108 or the video communication engine 124 at various intervals via a batch job, timer, etc.).

Based on the analysis performed in block 404, the method 500 highlights 506 the purchasable product to the user and/or displays 508 information in connection with the purchasable product. For instance, the client application 108 (e.g., identification module 322) can receive or generate product data that identifies the location of the product within the frame of the video communication session stream and display user-selectable overlays or other elements that visually highlight the product to the user. As a further example, the client application 108 can display a user-selectable bounding box around the product, a “purchase” icon or a “more details” icon proximate to the product, and/or some other user-selectable indicia that visually distinguishes the product/object to the user.

In another example, based on the product data, the method 500 may display an information region in association with the product, which includes detailed product information, such as a product title, a product description, product specifications and features, images of the product, product ratings and reviews, recommendations for the product, items related to the product, seller information, pricing information, comparison shopping information, shipping information, social network activity related to the product (e.g., number of times the product was shared, endorsed, posted about, etc.), and the like, as discussed elsewhere herein. The information region may be displayed responsive to the user selecting a product highlighted in block 506, may automatically be displayed, or may be displayed at the user's request or at the request of another user, etc. It should be understood that the above examples are provided by way of illustration and that numerous possibilities for highlighting and/or displaying information about the purchasable products are contemplated and within the scope of the disclosure.

The information highlighting the product and/or presented about the product may be interactive and may electronically link to other resources available on the client device 106 or coupled to the network 102. For instance, the information may include user-selectable electronic links (e.g., URIs, code, etc.) to other computing resources, such as the commerce engine 226, the commerce module 324, and/or the e-commerce application 130, and the user may select those links via user-selectable interface elements to comparison shop, further research a product, complete the purchase of a product, etc.

Responsive to processing blocks 506 and/or 508, the method 500 then receives input selecting 408 to purchase the product and the enables 410 the user to purchase the product, as discussed above with respect to method 400.

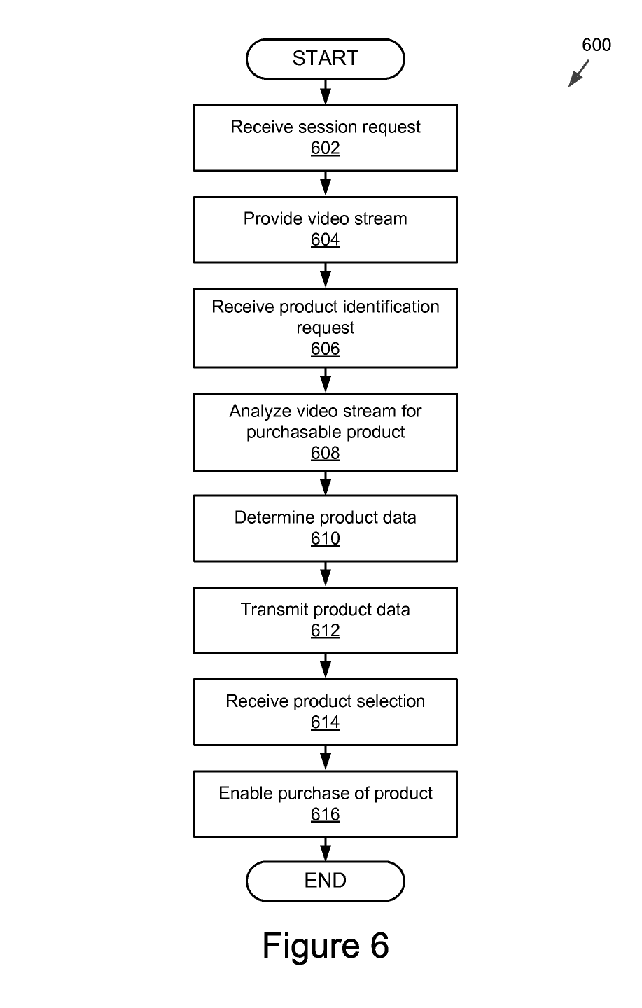

FIG. 6 is a flowchart of another example method 600 for identifying and enabling the purchase of a product in a video communication session. In block 602, the method 600 receives a session request from a first user to engage in a multi-user video communication session. In some embodiments, the session request may be a request from a first user to form a video communication session with one or more other users or may be an acceptance of a previously sent invitation to join a video communication sessions, as discussed elsewhere herein. Responsive to receiving the session request, the method 600 provides 604 a video communication session stream associated with the multi-user video communication session to the first user, which includes the video streams captured and provided by the other users of the session. For example, the video communication engine 124 may provide the video communication session stream to a client device 106 for presentation to the first user.

Next, the method 600 receives 606 a product identification request. In some embodiments, the product identification request may be received from the client device 106 of the first user. In other embodiments, the product identification request may be received from another user participating in the video communication session or a product identification request may not be required. The method 600 then analyzes 608 the video communication data stream in real time for a purchasable product being depicted by the video communication session stream. In some embodiments, the method 600 may analyze 608 the video communication session stream by detecting one or more product-like objects depicted by the video communication session stream and matching those objects to a plurality of products stored in a product database to identify whether they are purchasable. For instance, the product database may store a plurality of media objects respectively associated with the plurality of products, and the method 600 may generate a media object (e.g., a graphical image) of a product-like object detected by it in the video communication session stream and compare the media object to the plurality of media objects to identify the purchasable product. In various embodiments, the analyzing in block 608 may be performed responsive to receiving 606 the product identification request or may be performed automatically or autonomously.

The method 600 continues by determining 610 product data for the purchasable product and transmitting 612 the product data to one or more users of the video communication session (e.g., the first user). In some embodiments, the product data is determined 610 based on the analyzing 608. For example, the method 600 determines 610 the product data by retrieving it from a product database using an object detected by the analyzing. In some embodiments, the product data can include information describing a location of the purchasable product within the video communication session stream and/or attribute information describing the purchasable product.

The method 600 then transmits 612 the product data to the first user, and responsive there to, the method 600 receives 614 a product selection from the first user selecting the purchasable product. For instance, the video communication engine 124 may transmit product data to the client device 106 of the first user 114, the client application 108 may identify the purchasable product to the first user 114 based on the product data, the first user 114 may provide input selecting to compare prices for the purchasable product via the client application 108, and the client application may instruct the client device 106 to transmit the selection to the video communication engine 124 for processing. In these or other embodiments, the method 600 may transmit the product data to some or all participants of the video communication session. For example, a seller/user participating in the video communication session may request identification of one or more products included in the video communication session on behalf of one or more of the other participants and the method 600 may provide the product data determined responsive thereto to the one or more other participants for presentation and receive a product selection from the one or more other participants responsive thereto.

Next, the method 600 enables 616 the purchase of the selected product. For instance, the video communication engine 124 may provide comparison shopping functionality to the first user or one or more other users participating in the session, sell the product to the user(s) and place an order for it, redirect the user(s) to a seller/vendor of the product, and the like.

While methods 400, 500, and 600 are described within the context of a single product, it should be understood that one or more products may be processed (e.g., identified, purchased, etc.) by these methods. Furthermore, it should be understood that the embodiments described in this disclosure are provided by way of illustration and example and should not be considered limiting, and that other variations and combinations of these embodiments are contemplated and within the scope of the present disclosure. Moreover, unless stated otherwise, the various different embodiments described herein should not be considered as being mutually exclusive and can be integrated in various ways, or may be further divided into various discrete devices, components, and methods. For example, various operations of the methods 400, 500, or 600 may be expanded upon by operations included in the other methods, or by concatenating and/or substituting various blocks from these methods, all of which are encompassed by the present disclosure. Further, it should be understood that, in some instances, the methods 400, 500, and 600 may be iterated more than one time to produce various results. Additionally, the usage of the terms first, second, etc., in various places in this disclosure does not necessarily imply a specific order or rank, and is used in some cases to help the reader discern between various objects, items, elements, etc.

FIG. 7 is a graphic representation of an example user interface 700 for displaying a video communication session stream to a user highlighting a product and providing for purchase of the product. It should be understood that the user interface 700 illustrated in FIG. 7 is provided merely by way of example, and that numerous other user interfaces may be generated and displayed by the client application 108 to allow user to engage in video communication sessions, research, view, and purchase products, interact with others on the social network, etc. For example, various user interfaces may be produced to request information from and present information provided by the social network server 120, the e-commerce server 128, the client devices 106a . . . 106n, and any other entities coupled to the network 102.

As depicted, the user interface 700 includes a video region 702 for displaying the video communication session stream. While, in the depicted embodiment, the video region 702 depicts a single video stream, it should be understood that the video communication session stream may include a plurality of video streams. For example, the viewing user may be participating in a video communication session with four other users and four video streams, one for each of them, may be included in the video communication session stream and displayed in the video region 702. For instance, the video streams of the other users participating in the video communication session may be tiled within the video region 702. Additionally, the user may toggle his/her the display of his/her own video stream one or off so the user may see how he/she looks to the other participants in the video communication session.

The video region 702 includes a product 704, a user-selectable highlighter 706 for highlighting the product 704 to the viewing user, and an information region 708. Selection by the user of the highlighter 706 or interactive information included within the highlighter 706 or the information region 708 may allow the user to obtain additional information about the product 704, shop for the product 704, compare prices for the product 704, purchase the product 704, or perform other related actions.

In the above description, for purposes of explanation, numerous specific details are set forth in order to provide a thorough understanding of the specification. It should be understood that the technology described herein can be practiced without these specific details. In other instances, structures and devices are shown in block diagram form in order to avoid obscuring the description. For example, the present embodiment is described in one embodiment below primarily with reference to user interfaces and particular hardware. However, the present embodiment applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment of the description. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present embodiment of the specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware embodiment, an entirely software embodiment or an embodiment containing both hardware and software elements. In a preferred embodiment, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description below. In addition, the specification is not described with reference to any particular programming language. It will be appreciated that a variety of programming languages may be used to implement the teachings of the specification as described herein.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A method comprising:
providing, using one or more computing devices, a video communication session stream associated with a multi-user video communication session to a client device of a user participating in the video communication session for presentation;
receiving, using the one or more computing devices, a product identification request;
responsive to the receiving of the product identification request, analyzing, using the one or more computing devices, the video communication session stream in real time for a purchasable product being depicted by the video communication session stream;
determining, using the one or more computing devices, product data for the purchasable product based on the analyzing of the video communication session stream;
transmitting, using the one or more computing devices, the product data to the client device for presentation;
receiving, using the one or more computing devices, a product selection from the client device selecting the purchasable product; and
enabling, using the one or more computing devices, a purchase of the purchasable product by the user.

2. A method comprising:
providing, using one or more computing devices, a video communication session stream associated with a multi-user video communication session to a client device of a user for presentation;
analyzing, using the one or more computing devices, the video communication session stream in real time for a purchasable product being depicted by the video communication session stream;
determining, using the one or more computing devices, product data for the purchasable product based on the analyzing of the video communication session stream; and
transmitting, using the one or more computing devices, the product data to the client device for presentation.

3. The method of claim 2, wherein the analyzing of the video communication session stream includes detecting an object depicted by the video communication session stream and matching the object to one of a plurality of products stored in a product database to identify the purchasable product.

4. The method of claim 3, wherein the object is a media object, the product database stores a plurality of media objects respectively associated with the plurality of products, and the matching of the object includes comparing the media object to the plurality of media objects to identify the purchasable product.

5. The method of claim 2, wherein the product data includes one or more of information describing a location of the purchasable product within the video communication session stream and attribute information for the purchasable product.

6. The method of claim 2, further comprising:
receiving, using the one or more computing devices, a product identification request, wherein the analyzing of the video communication session stream in real time is performed responsive to the receiving of the product identification request;

7. The method of claim 2, further comprising:
receiving, using the one or more computing devices, a product selection from the client device selecting the purchasable product; and
enabling, using the one or more computing devices, a purchase of the purchasable product by the user.

8. The method of claim 2, further comprising:
receiving, using the one or more computing devices, a request to engage in the video communication session from the client device prior to the providing of the video communication session stream.

9. A system comprising:
one or more processors, the processors being configured to:
provide a video communication session stream associated with a multi-user video communication session to a client device of a user for presentation;
analyze the video communication session stream in real time for a purchasable product being depicted by the video communication session stream;
determine product data for the purchasable product based on the analyzing of the video communication session stream; and
transmit the product data to the client device for presentation.

10. The system of claim 9, wherein to analyze the video communication session stream includes detecting an object depicted by the video communication session stream and matching the object to one of a plurality of products stored in a product database to identify the purchasable product.

11. The system of claim 10, wherein the object is a media object, the product database stores a plurality of media objects respectively associated with the plurality of products, and the matching of the object includes comparing the media object to the plurality of media objects to identify the purchasable product.

12. The system of claim 9, wherein the product data includes one or more of information describing a location of the purchasable product within the video communication session stream and attribute information for the purchasable product.

13. The system of claim 9, wherein the one or more processors are further configured to:
receive a product identification request, wherein the analyzing of the video communication session stream in real time is performed responsive to the product identification request being received;

14. The system of claim 9, wherein the one or more processors are further configured to:
receive a product selection from the client device selecting the purchasable product; and
enable a purchase of the purchasable product by the user.

15. The system of claim 9, wherein the one or more processors are further configured to:
receive a request to engage in the video communication session from the client device prior to the providing of the video communication session stream.
